(19) United States
(12) Patent Application Publication
(10) Pub. No.: US 2026/0080537 A1
(43) Pub. Date: Mar. 19, 2026

(54) TECHNIQUES FOR MONITORING GROWTH OF A MEDICAL CONDITION USING DEEP LEARNING

(71) Applicant: L&T TECHNOLOGY SERVICES LIMITED, Chennai (IN)

(72) Inventors: AJITH KOLAR JAYASHANKARA, Mysuru (IN); NETHRAVATHI AGATHAGOWDANAHALLI MAHADEVAIAH, Chamrajnagar (IN)

(21) Appl. No.: 19/318,384

(22) Filed: Sep. 4, 2025

(30) Foreign Application Priority Data
Sep. 13, 2024 (IN) 202441070180

(51) Int. Cl. G06T 7/00; G06T 7/11

(52) U.S. Cl. CPC G06T 7/0014; G06T 7/11; G06T 2207/20081; G06T 2207/30096

(57) ABSTRACT

The present disclosure is directed to method and apparatus for monitoring growth of a medical condition in a subject. The apparatus comprises a processor configured to process, using a trained modality classification model, at least two input medical images representing the medical condition to identify an image modality, among a plurality of image modalities, associated with the input medical images. The processor is further configured to process the input medical images using a segmentation model to generate at least two segmented images corresponding to the input medical images. The processor is further configured to process the input medical images and the segmented images to extract at least two sets of radiomic features corresponding to the input medical images and monitor the growth of the medical condition by comparing corresponding radiomic features of the sets of radiomic features.

### TECHNICAL FIELD

The present disclosure generally relates to Machine Learning. More particularly, but not exclusively, the present disclosure relates to methods and apparatuses for monitoring growth of a medical condition in a subject using Deep Learning (DL).

### BACKGROUND

Medical science and research is constantly advancing. However, as the medical science is advancing, new and more complex medical conditions (also referred to as “diseases” in the present disclosure) are also emerging. These medical conditions need to be detected at early stage and more specifically, their growth or progression needs to be closely monitored. For example, cancer (also referred to as “tumor”) is one such medical condition where constant monitoring is necessary for proper treatment of subjects. Traditionally, doctors and/or specialists used to monitor the growth of the medical conditions based on own knowledge/skills and experience e.g., by manually examining patients and/or examining medical images. However, such manual process was tedious and prone to human errors because the detection/monitoring accuracy was dependent on the skills and/or experience of the doctors and/or specialists.

To overcome the limitations associated with the manual process, Artificial Intelligence (AI) based solutions have been developed. Such solutions typically utilize trained models for detection of the medical conditions and monitoring the growth of the medical conditions. However, the limitations of such solutions is that they require different AI models for different types of medical images and each model has to be trained individually and then deployed (e.g., on different hardware systems) which increases overall complexity. Moreover, such approach (i.e., individually training and deploying different models) is resource consuming (consumes extensive computing resources) and is not cost-effective because maintaining multiple models designed for various tasks is a challenging task. Hence, there exists a need for techniques to overcome the above-mentioned and other related challenges.

The information disclosed in this background section is only for enhancement of understanding of the general background of the disclosure and should not be taken as an acknowledgement or any form of suggestion that this information forms the prior art already known to a person skilled in the art.

### SUMMARY

Embodiments of the present disclosure are directed to methods and systems for monitoring growth of a medical condition in a subject and for predicting likelihood of reoccurrence of the medical condition.

In one non-limiting embodiment of the present disclosure an apparatus for monitoring growth of a medical condition in a subject. The apparatus comprises a memory and a processor communicatively coupled with the memory. The processor is configured to process, using a trained modality classification model, at least two input medical images representing the medical condition to identify an image modality, among a plurality of image modalities, associated with the at least two input medical images. The processor is further configured to process the at least two input medical images using a segmentation model which is specifically trained for the identified image modality to generate at least two segmented images corresponding to the at least two input medical images. The processor is further configured to process the at least two input medical images and the at least two segmented images to extract at least two sets of radiomic features corresponding to the at least two input medical images, and monitor the growth of the medical condition in the subject by comparing corresponding radiomic features of the at least two sets of radiomic features.

In another non-limiting embodiment, the present disclosure discloses a method for monitoring growth of a medical condition in a subject. The method comprises processing, using a trained modality classification model, at least two input medical images representing the medical condition to identify an image modality, among a plurality of image modalities, associated with the at least two input medical images. The method further comprises processing the at least two input medical images using a segmentation model which is specifically trained for the identified image modality to generate at least two segmented images corresponding to the at least two input medical images. The method further comprises processing the at least two input medical images and the at least two segmented images to extract at least two sets of radiomic features corresponding to the at least two input medical images. The method further comprises monitoring the growth of the medical condition in the subject by comparing corresponding radiomic features of the at least two sets of radiomic features.

The foregoing summary is illustrative only and is not intended to be in any way limiting. In addition to the illustrative embodiments, and features described above, further embodiments, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and, together with the description, serve to explain the disclosed principles. Some embodiments of system and/or methods in accordance with embodiments of the present subject matter are now described, by way of example only, and with reference to the accompanying Figures, in which:

FIG. 1 illustrates an exemplary environment or communication system 100 in which the techniques consistent with the present disclosure may be implemented, in accordance with some embodiments of the present disclosure.

FIG. 2 shows an example pipeline or workflow 200 integrating major operations involved in monitoring growth of the medical condition and predicting chances of reoccurrence, in accordance with some embodiments of the present disclosure.

FIG. 3(a)-3(b) illustrate two exemplary input medical images representing a medical condition of a subject, in accordance with some embodiments of the present disclosure.

FIG. 3(c)-3(d) illustrate two exemplary segmented images corresponding to the input medical images of FIG. 3(a)-(b), in accordance with some embodiments of the present disclosure.

FIG. 4 illustrates an exemplary U-Net architecture 400, in accordance with some embodiments of the present disclosure.

FIG. 5(a)-5(b) illustrates two exemplary sets of radiomic features corresponding to the input medical images of FIG. 3(a)-(b), in accordance with some embodiments of the present disclosure.

FIG. 5(c) shows progression or growth analysis 502 of the medical condition,, in accordance with some embodiments of the present disclosure.

FIG. 6 shows a flowchart illustrating a method 600 for monitoring growth of a medical condition in a subject, in accordance with some embodiments of the present disclosure.

It should be appreciated by those skilled in the art that any block diagrams herein represent conceptual views of the illustrative systems embodying the principles of the present subject matter. Similarly, it will be appreciated that any flowcharts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration. ” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however, that it is not intended to limit the disclosure to the particular form disclosed, but on the contrary, the disclosure is to cover all modifications, equivalents, and alternatives falling within the spirit and the scope of the disclosure.

The terms “comprise(s)”, “comprising”, “include(s)”, or any other variations thereof, are intended to cover a non-exclusive inclusion, such that a setup, device, apparatus, system, or method that comprises a list of components or steps does not include only those components or steps but may include other components or steps not expressly listed or inherent to such setup or device or apparatus or system or method. In other words, one or more elements in a device or system or apparatus proceeded by “comprises . . . a” does not, without more constraints, preclude the existence of other elements or additional elements in the system.

In the following detailed description of the embodiments of the disclosure, reference is made to the accompanying drawings that form a part hereof, and in which are shown by way of illustration of specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense. In the following description, well known functions or constructions are not described in detail since they would obscure the description with unnecessary detail.

The terms like “at least one” and “one or more” may be used interchangeably throughout the description. The terms like “a plurality of” and “multiple” may be used interchangeably throughout the description. In the context of present disclosure, the terms “medical condition” and “diseases” may be used interchangeably. In the context of present disclosure, the terms “cancer” and “tumor” may be used interchangeably. In the context of present disclosure, the terms “subject” and “patient” may be used interchangeably. In the context of present disclosure, the terms “model”, “data model”, “ML model”, “AI model”, “DL model” are used interchangeably to refer to a Machine Learning (ML) and/or Artificial Intelligence (AI) and/or Deep Learning (DL) based data model that is trained using one or more training techniques.

In the context of the present disclosure, a “medical image” refers to an image of interior of a body for clinical analysis and medical study. Such image is generated using various medical imaging techniques such as X-ray, Magnetic Resonance Imaging (MRI), Computed Tomography (CT) Scans, Positron Emission Tomography (PET) scans, Ultrasound. However, the present disclosure is not limited thereto, and the techniques of the present disclosure are equally applicable for a wide range of medical images. These different types of medical images may be referred to as “image modality”. Typically, a “medical condition” refers to any health issue or diseases that impacts a person's ability to function normally. The present disclosure is explained by considering the medical condition as cancer and/or tumor. However, the present disclosure is not limited thereto, and the techniques of the present disclosure are equally applicable for a wide range of medical conditions.

Artificial Intelligence (AI) has become an integral part of our daily lives, as AI is applied in various aspects of day-to-day activities. The AI includes Machine Learning and Deep Learning and uses various concepts from statistics to build models that can learn patterns from historical data to predict new output values. An AI model is an object which is trained using AI techniques for recognizing certain types of patterns or make certain predictions for an unseen dataset. Typically, AI models are mathematical representations of data, specifically designed to enable computers to learn from past experiences rather than through explicit instructions. Due to its applications over a wide variety of fields, AI has seen immense growth in medical industry.

As discussed in the background section, in some solutions, trained AI models are used for detection of tumors in subjects (e.g., patients) and monitoring the growth of the tumors. However, the limitations of such solutions is that they require separate training and deployment of different AI models for different types of medical images. For example, if the medical images include X-ray, MRI, CT Scans, PET scans, Ultrasound, Endoscopy, Mammography, Bone scan, and then one AI model is needs for processing X-ray medical images, one AI model is needs for processing MRI based medical images, one AI model is needs for processing PET Scan based medical images, one AI model is needs for processing ultrasound based medical images, and the like. Such approach of individually training and then deploying different models consumes extensive computing resources and time, and is also not cost-effective because maintaining multiple models designed for various tasks is a challenging task, thereby degrading overall performance of computing devices/systems.

The present disclosure overcome this and other related problems and provide resource and time efficient techniques for efficiently monitoring growth of various medical conditions in subjects. Specifically, the present disclosure provides robust and effective techniques for efficiently monitoring growth of different medical conditions using a single AI model which is specifically trained to process different modalities of input images. The forthcoming paragraphs now describe the proposed techniques of monitoring growth of medical conditions in subjects.

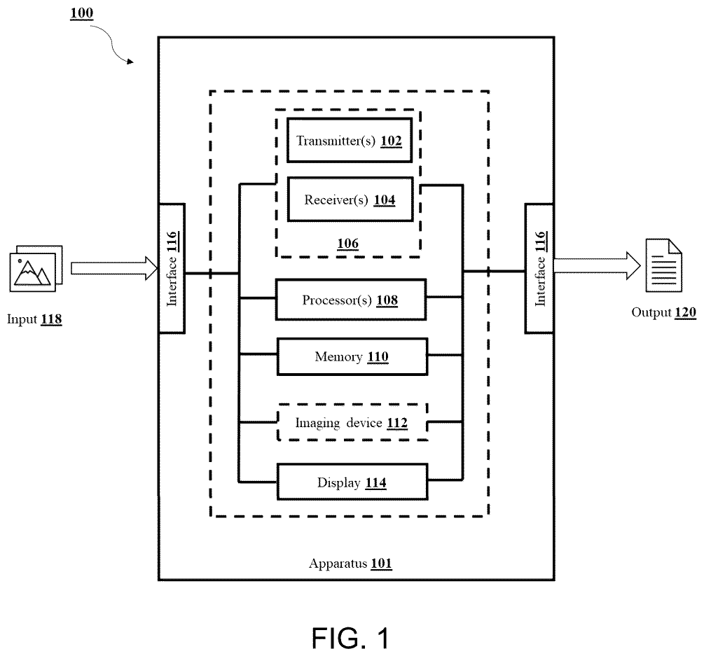

Referring to FIG. 1, which illustrates an exemplary environment 100 in which the techniques consistent with the present disclosure may be implemented, in accordance with some embodiments of the present disclosure. The environment 100 may comprise an apparatus or computing system 101 (referred to as “growth monitoring and reoccurrence prediction system” or “system”) which may be in communication with one or more other devices. The apparatus 101 may be configured to monitor growth of medical conditions and predict chances of reoccurrence of the medical conditions, according to the techniques disclosed in the present disclosure.

The apparatus 101 may comprise at least one transmitter 102, at least one receiver 104, at least one processor 108, at least one memory 110, at least one imaging device 112, at least one display 114, at least one input/output interface 116, and at least one antenna (not shown). The at least one receiver 104 may be configured to receive or fetch input data 118 from one or more nodes/devices (e.g., over a communication network and via an input interface 116). In one example, the input data 118 may be training datasets (e.g., fetched from any external database). In another example, the input data 118 may be inferencing data for which inferencing is required. The at least one transmitter 102 may be configured to transmit output data 120 to one or more nodes/devices (e.g., over a communication network and via an output interface 116). The output data 120 may be output of AI models (e.g., prediction results, trained AI models, etc.). The at least one transmitter and receiver may be collectively implemented as a single transceiver module 106. In one non-limiting embodiment, the at least one processor 108 may be communicatively coupled with the transceiver 106, the memory 110, the imaging device 112, the display 114, and the interface 116 (e.g., via a communication channel or bus).

The communication network may comprise a data network such as, but not restricted to, the Internet, Local Area Network (LAN), Wide Area Network (WAN), Metropolitan Area Network (MAN), etc. In certain embodiments, the network may include a wireless network, such as, but not restricted to, a cellular network and may employ various technologies including Enhanced Data rates for Global Evolution (EDGE), General Packet Radio Service (GPRS), Global System for Mobile Communications (GSM), Internet protocol Multimedia Subsystem (IMS), Universal Mobile Telecommunications System (UMTS) etc. In one embodiment, the network may include or otherwise cover networks or subnetworks, each of which may include, for example, a wired or wireless data pathway.

The at least one processor 108 may include, but not restricted to, microprocessors, microcomputers, micro-controllers, central processing units, state machines, logic circuitries, and/or any devices that manipulate signals based on operational instructions. The processor 108 may also be implemented as a combination of computing devices, e.g., a combination of a plurality of microprocessors or any other such configuration.

The at least one memory 110 may be communicatively coupled to the at least one processor 108 and may comprise various types of data/information and instructions. The data/information stored in the memory 110 may comprise cached data, training dataset(s), validation/testing dataset(s), real-time inferencing data, information regarding a plurality of training techniques, trained AI models, log data of the AI models, but not limited thereto. The at least one memory 110 may include a Random-Access Memory (RAM) unit and/or a non-volatile memory unit such as a Read Only Memory (ROM), optical disc drive, magnetic disc drive, flash memory, Electrically Erasable Read Only Memory (EEPROM), a memory space on a server or cloud and so forth. The at least one processor 108 may be configured to execute the instructions stored in the memory 110 for implementation of the proposed techniques.

In one example, the imaging device 112 may be configured to capture medical images (e.g., medical images of subjects) for monitoring growth of medical condition in a subject and chances of reoccurrence. The medical images may comprise X-ray, MRI, CT Scans, PET scans, Ultrasound, Endoscopy, Mammography, Bone scan, but not limited thereto. In another example, the medical images of the subject may be captured using a separate image capturing device and the apparatus 101 may receive the captured medical images for monitoring growth of the medical condition in the subject and predicting chances of reoccurrence.

The display 114 may be used to present information visually. The display 114 may present a dashboard showing growth of the medical condition and the chances of reoccurrence. In one example, the dashboard reflects status of each deployed AI model including data health and model health metrics. In some examples, the display 114 may serve as a user interface through which a user may interact with the apparatus 101. The interfaces 116 may include a variety of software and hardware interfaces, for example, a web interface, a graphical user interface, an input device-output device (I/O) interface, a network interface and the like. The I/O interfaces may allow the apparatus 101 to communicate with one or more nodes/devices either directly or through other devices. The network interface may allow the apparatus 101 to interact with one or more networks either directly or via any other network.

In one example, the apparatus 101 may refer to any mobile or non-mobile computing system located at the premises of a doctor (e.g., in a clinic, hospital, laboratory, but not limited thereto). Examples of such devices may include smartphones, tablets, laptops, desktop computers, IoT devices, a portable computing device, or any other suitable computing device including a wired and/or wireless communications interface. In another example, the apparatus 101 may be hosted on a remote server or may reside on premises of a service provider. In such example, an admin device (e.g., located at the premises of the doctor) may remotely control the operations of the apparatus 101 over a network.

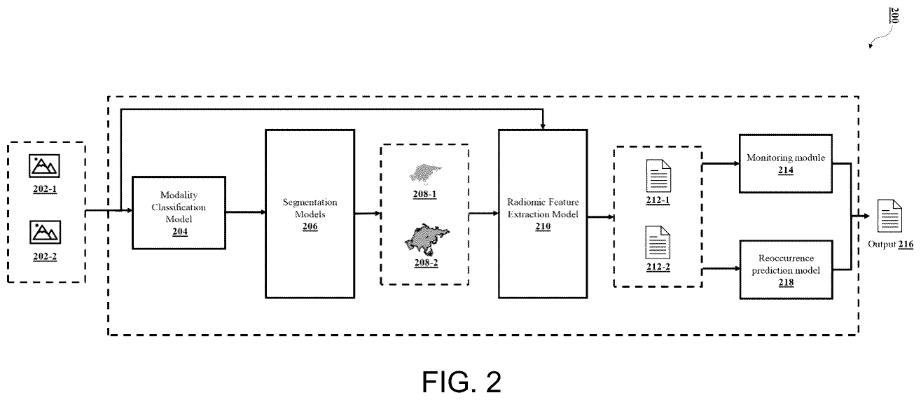

FIG. 2 shows an example pipeline or workflow 200 integrating major operations involved in monitoring growth of the medical condition in the subject and predicting chances of reoccurrence, in accordance with some embodiments of the present disclosure. The techniques discussed in connection with FIG. 2 may be implemented using the apparatus 101 and specifically, using the processor 108 in conjunction with the various other components of the apparatus 101 as shown in FIG. 1. The workflow 200 shown in FIG. 2 illustrates various models (which are typically AI based trained models) such as modality classification model 204, a plurality of (medical image) segmentation models 204, a radiomic feature extraction model 210, a monitoring module 214, and a reoccurrence prediction model or trained radiomic feature classification model 218. It may be noted that the AI models shown in FIG. 2 are first trained and then deployed for inferencing.

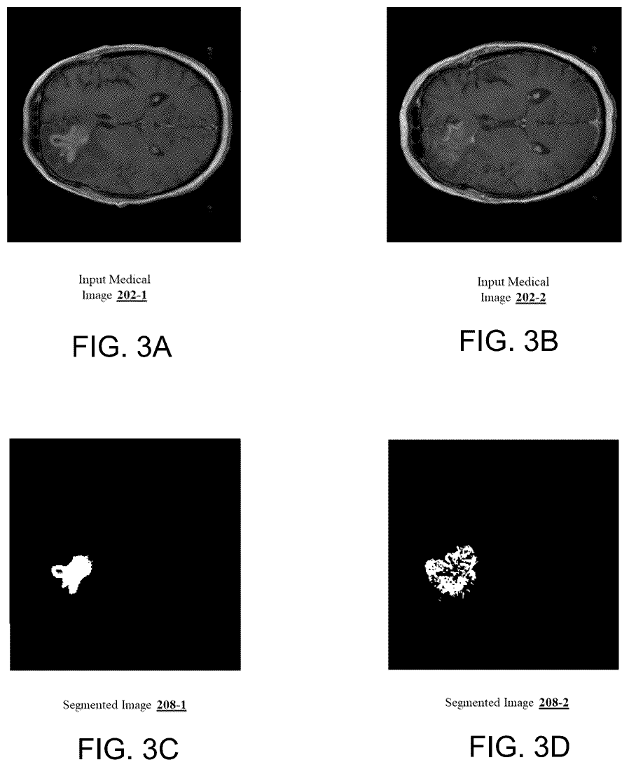

Initially, the processor 108 may receive two medical images 202-1, 202-2 representing the medical condition of a subject (or a patient). The medical condition comprises tumor, lesions, or organs that need to be analyzed, or cancer, or other related or similar medical conditions which is visually represented using medical images. The two medical images are typically captured at two different time instances. For example, the first image 202-1 may be captured 6-months earlier compared to the second image 202-2. However, the present disclosure is not limited thereto and there may be any sufficient time gap between capturing of the two images (as per requirement). In one example, the processor 108 may capture the two medical images 202-1, 202-2 using the imaging device 112 of FIG. 1. In another example, the processor 108 may receive already captured images (e.g., captured by a different imaging device). The two medical images 202-1, 202-2 belong to same modality. Here modality refers to a type of medical images among X-ray, MRI, CT Scans, PET scans, Ultrasound, Endoscopy, Mammography, Bone scan, etc. Two exemplary input MRI medical images representing a medical condition of a subject are shown in FIG. 3(a) and 3(b). FIG. 3(a) shows the input MRI medical image 202-1 and FIG. 3(b) shows the input MRI medical images 202-2.

The processor 108 may process the two input medical images using the trained modality classification model 204 to identify an image modality, among a plurality of image modalities, associated with the two input medical images 202-1, 202-2. The modality classification model 204 is typically a DL model which is specifically trained to identify a modality or type of any input medical image among a plurality of image modalities. The modality classification model 204 may be a biomedical vision-language foundation model that is pretrained on a large medical dataset using contrastive learning.

In one example, the modality classification model 204 may be a zero-shot image classification model. Typically, zero-shot image classification is an advanced machine learning task where a model classifies images into categories which are never encountered during training of the model. In conventional image classification, a model is trained using a dataset where each image is labeled with a corresponding category/label and during the training, the model learns to map certain features or patterns in the image to specific labels. When introduced to new and unseen labels, the models usually need fine-tuning or retraining to handle the new labels. In contrast, zero-shot image classification does not need retraining when new categories are introduced. The zero-shot image classification models are often multi-modal which are trained on large datasets of both images and associated text descriptions. By learning the relationship between visual features (i.e., the image) and language (i.e., the description), such models develop aligned vision-language representations. In this manner, zero-shot image classification allows models to generalize to new and unseen data without the need for additional training data.

The processor 108 may process the two input medical images 202-1, 202-2 using the trained modality classification model 204 to identify an image modality or an image type of the two input medical images 202-1, 202-2 among a plurality of modalities which includes X-ray, MRI, CT Scans, PET scans, Ultrasound, Endoscopy, Mammography, Bone scan, but not limited thereto. Consider that the modality of the two input medical images 202-1, 202-2 (shown in FIG. 3(a)-3(b)) is identified as MRI.

The processor 108 may then perform segmentation on the two input medical images 202-1, 202-2. In image segmentation, an input image is partitioned the image into different segments each representing a different entity. Initially, the processor 108 may select a suitable medical image segmentation model for the identified image modality among a plurality of trained segmentation models 206 corresponding to the plurality of image modalities. The plurality of trained segmentation models 206 is typically an ensemble or a multi-modal image segmentation model which comprises one trained model for one type of medical image.

For instance, the plurality of image modalities comprises medical imaging techniques including: X-Ray, Magnetic Resonance Imaging (MRI) scan, Computed Tomography (CT) scan, Ultrasound, Positron Emission Tomography (PET), Endoscopy, Mammography, Bone scan, etc. In such example, the plurality of trained segmentation models 206 comprises one trained model for processing X-ray medical images, one trained model for processing MRI medical images, one trained model for processing CT scan medical images, one trained model for processing ultrasound medical images, one trained model for processing PET scan medical images, one trained model for processing endoscopy medical images, one trained model for processing Mammography medical images, one trained model for processing Bone scan medical images.

Depending on the identified modality of the two input medical images 202-1, 202-2, the processor 108 may select a corresponding trained segmentation model of the plurality of trained segmentation models for processing the input images 202-1, 202-2. The segmentation model is a deep learning model trained to identify regions of interest corresponding to the medical condition in input medical images of the identified image modality. The processor 108 may process the two input medical images 202-1, 202-2 using the selected trained segmentation model (which is specifically trained for the identified image modality) to generate two segmented images or segmentation maps 208-1, 208-2 corresponding to the two input medical images 202-1, 202-2. Two exemplary segmented images are shown in FIG. 3(c) and 3 [symbol] d [symbol] . FIG. 3(c) shows the segmented image 208-1 for the input MRI medical image 202-1 and FIG. 3(d) shows the segmented image 208-2 for the input MRI medical image 202-2.

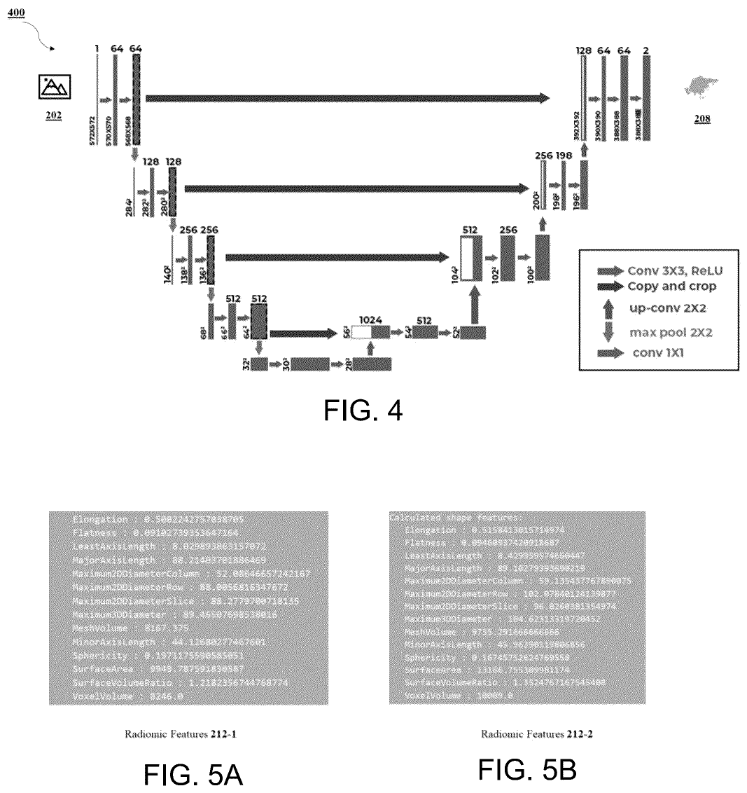

As mentioned above the image segmentation is a technique of partitioning an input image into different segments. Traditionally, Convolutional Neural Networks (CNN) were used for image segmentation. However, the CNNs do not perform better on complex images such as medical images. Thus, the techniques of the present disclosure utilize U-Net architecture for medical image segmentation. In other words, the multi-modal image segmentation model may be trained based on the U-Net Architecture, as shown in FIG. 4.

FIG. 4 illustrates an exemplary U-Net architecture 400 comprising three paths i.e., a contracting path (down sampling), a bottleneck path (middle), and an expansion path (up sampling). The contracting path comprises several blocks that reduce an image size but increase a number of features. Each block applies two 3×3 convolution layers and a 2×2 max-pooling layer, which helps to extract important features from the image while reducing its size. The Bottleneck Path acts as a connection between the contracting and expanding paths. The bottleneck path applies two 3×3 convolution layers followed by a 2×2 up-convolution layer for reconstructing image in the next stage. The expanding path mirrors the contracting path. For each block, two 3×3 convolution layers are applied followed by a 2×2 up-sampling layer, which increases the image size again. There are as many blocks in this path as in the contracting path. At the end, another 3×3 convolution layer creates the final output map, where the number of channels matches a number of classes or segments to be identified in the image.

FIG. 4 illustrates the U-Net architecture 400 for converting a grayscale input image 202 of size 572×572×1 into a binary segmented output map 208 of size 388×388×2. As the input image passes through the contracting path, image size decreases, but the number of feature channels increases to capture more abstract features. The bottleneck path generates a feature map of size 30×30×1024. Then, the expanding path uses up-sampling layers to increase the image size back to the original. Along the way, skip connections from the contracting path help refine details in the final segmented image, where each pixel represents either a foreground or background.

Training a multi-modal image segmentation model using the U-Net architecture 400 may comprise combining multiple types of input data (modalities), such as medical images of different types to improve segmentation performance. To handle multi-modal input data, the input layer of the U-Net Architecture 400 may be modified to accept different kinds of modalities. In one example, the model may be trained using a gradient-based optimizer. During the training, the model typically learns to minimize a difference between a predicted segmentation map and ground truth. After training, model performance may be evaluated on a validation dataset comprising same multi-modal input data. Once trained, the model may produce accurate segmentation maps for all types of input modalities.

Referring back to FIG. 2, post generating the two segmented images 208-1, 208-2 corresponding to the two input medical images 202-1, 202-2, the processor 108 processes the two input medical images 202-1, 202-2 along with the two segmented images 208-1, 208-2 using a radiomic feature extraction model 210. Such processing results in extraction of two sets of radiomic features 212-2, 212-2 corresponding to the two input medical images 202-1, 202-2. Generally, the radiomic features are quantitative descriptors that convert visual information from medical images (such as X-rays, CT scans, MRIs, PET scans, etc.) into data with information about shape, size, texture, intensity, patterns, etc. within a Region of Interest (ROI). The ROI may correspond to the medical condition e.g., the tumor. The radiomic feature extraction model 210 may be PyRadiomics. However, the present disclosure is not limited thereto.

Each of the two input medical images 202-1, 202-2 comprises a regions of interest (ROI) which corresponds to the medical condition such as the tumor. The two corresponding segmented images 208-1, 208-2 identify specific regions (such as region corresponding to the tumor) from which radiomic features are to be extracted. The segmented images comprises binary masks or labelled imaged where a ROI is marked/highlighted (with values like 1 for the ROI and 0 for the background), as shown in FIG. 3(c)-3(d) so that the radiomic feature extraction model may focus only on the relevant area within the medical images. In simple words, the segmented images indicate which parts of the input medical images should be analyzed for radiomic feature extraction. The processor 108 processes the two input medical images 202-1, 202-2 in conjunction with the two segmented images 208-1, 208-2 (e.g., with the help of the radiomic feature extraction model 210) to extracts various features from each of the input medical images 202-1, 202-2 within the segmented region or within the ROIs.

Specifically, the processor 108 may first overlap or align the segmented image (e.g., 208-1) with the corresponding input medical image (e.g., 202-1) so that the segmented region or ROI of the segmented image precisely matches a spatial location in the original input medical image. Once the segmented image 208-1 is overlaid on the input medical image 202-1, the processor 108 identifies a specific ROI corresponding to the spatial location within the input medical image 202-1. The processor 108 then focusses on the specific ROI within the input image that contains relevant information (e.g., related to tumor) while ignoring surrounding healthy tissues to extract a first set of radiomic features 212-1 corresponding to the input medical image 202-1. Likewise, the processor 108 processes the segmented image 208-2 along with the corresponding input medical image 202-2 to extract a second set of radiomic features 212-2 corresponding to the input medical image 202-2.

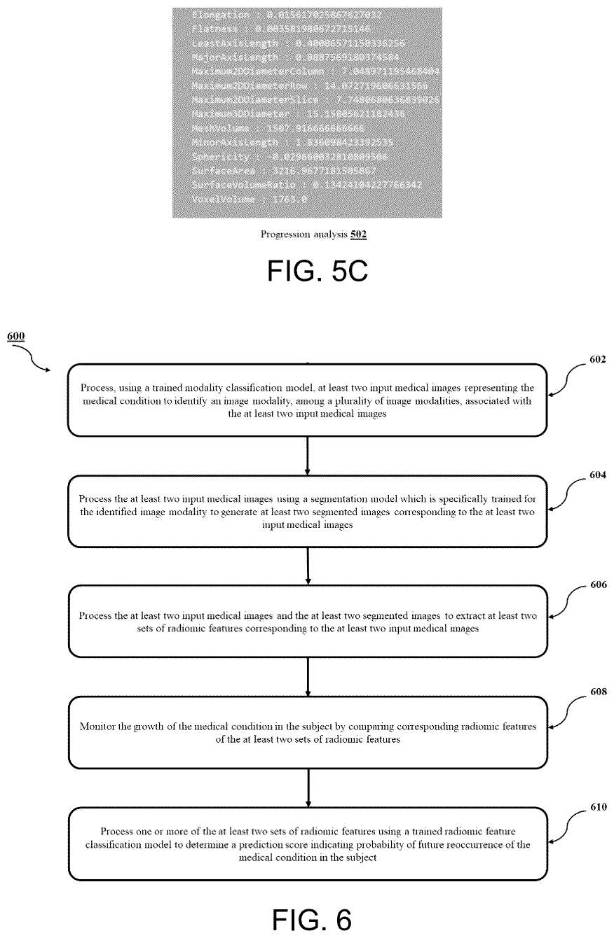

Consider that the radiomic features extracted by the processor 108 may comprise: elongation, flatness, least axis length, major axis length, maximum 2D diameter column, maximum 2D diameter row, maximum 2D diameter slice, maximum 3D diameter, mesh volume, minor axis length, sphericity, surface area, surface volume ratio, voxel volume, but not limited thereto. Two exemplary sets of radiomic features are shown in FIG. 5(a) and 5(b). FIG. 5(a) shows the set of radiomic features 212-1 extracted from the input medical image 202-1 and FIG. 5(b) shows the set of radiomic features 212-2 extracted from the input medical image 202-2.

Post extracting the radiomic features, the processor 108 may monitor the growth or progression of the medical condition in the subject by comparing corresponding radiomic features of the two sets of radiomic features using the monitoring module 214. The two input medical images 202-1, 202-2 are captured at different time instances during lifetime of the subject and the processor 108 may monitor the growth or progression of the medical condition in the subject between the different time instances by comparing the corresponding radiomic features using the monitoring module 214. Consider that the first image 202-1 was captured 6-months earlier compared to the second image 202-2. In that case, the processor 108 may monitor the growth or progression of the medical condition over the time period of 6-months by calculating differences in the corresponding radiomic features of the two sets 212-1, 212-2 to monitor the growth of the medical condition in the subject. For comparison, the monitoring module 214 compares each radiomic feature of the input medical image 202-1 with its corresponding radiomic feature of the input medical image 202-2 and stores the result of comparison in an output file 216, as shown in FIG. 2.

FIG. 5(c) shows progression or growth analysis 502 (which is a part of the output file 216) which comprises differences between the radiomic features 212-1 (or radiomic feature values) extracted from the input medical image 202-1 and radiomic features 212-2 extracted from the input medical image 202-2. The progression analysis 502 of FIG. 5(c) indicates that the medical condition (i.e., tumor) has grown over the period of 6 months.

Referring back to FIG. 2, after extracting the two sets of radiomic features, the processor 108 may process at least one of the two sets of radiomic features 212-1, 212-2 using a trained radiomic feature classification model or reoccurrence prediction model 218 to determine a prediction score indicating probability of future reoccurrence of the medical condition in the subject and stores the prediction score in the output file 216, as shown in FIG. 2. In one example, the radiomic feature classification model 218 may be trained using EfficientNet-V2 with a dataset which comprises one-time features and reoccurred features. Here, one-time radiomic features are radiomic features extracted from medical images which indicated that tumors that did not reoccur i.e., tumor was treated successfully. The reoccurred radiomic features are those radiomic features extracted from medical images which indicated that tumor reoccurred after treatment. The goal of the training process is to generate a model that can accurately classify whether a medical condition (e.g., a tumor) is likely to recur based on the radiomic features extracted from medical images.

EfficientNet-V2 is typically designed for image data (2D inputs) but the radiomic features are typically 1D feature vectors. To handle these vectors, few layers of the network may be adapted/modified. The radiomic feature classification model 218 is trained to minimize a difference between a predicted output (a probability of tumor recurrence) and the actual label (whether the tumor reoccurred or not). As the model 218 is being trained, the model 218 is periodically evaluated on a validation set to monitor model performance and avoid overfitting.

Once the training is complete and the model 218 is fine-tuned, the model 218 can be used to make predictions on new radiomic feature sets. The trained radiomic feature classification model 218 may recognize patterns in input radiomic features and predict outcomes or scores indicating likelihood of recurrence of the medical condition. In one example, the outcome indicates a probability or risk that the medical condition will reoccur in future. The prediction score is typically a number between 0 and 1, representing the likelihood of recurrence. A prediction score close to 0 indicates a low probability of recurrence, while a prediction score close to 1 indicates a high probability of recurrence. For example, if the prediction score is 0.85, it indicates that there are 85% chance that the medical condition will re-occur.

In one embodiment, the processor 108 may provide an indication related to the growth of the medical condition and the future reoccurrence of the medical condition. In one example, the processor 108 may display the output results 216 on the display 114 or may transmit the output results 216 to a doctor, a patient, a specialist, etc.

In this manner, the techniques of the present disclosure efficiently process medical images (e.g., consecutive medical images) to accurately monitor growth or progress of a medical condition in a patient and predict chances of reoccurrence (even in complex or irregularly shaped medical conditions e.g., tumors). The techniques of the present disclosure employ a single pipeline and a single multi-modal segmentation model that is designed to process various types of input medical images. By using a single multi-modal segmentation model, the proposed techniques reduce the computational burden that would otherwise be required if separate models were needed for each image modality. In this manner, the techniques of the present disclosure save computing resources, reduce the risk of human error, and reduce operational costs. Further, the proposed pipeline minimizes the need for manual interventions, thereby saving significant time and operational costs. The proposed pipeline can analyze consecutive medical images taken over time to track growth or progression of a medical condition, such as tumor growth. Such sequential analysis helps in assessing evolution of the medical condition and provides timely treatment. The techniques of the present disclosure provide data-driven insights for proactive and effective management of medical conditions.

It may be noted that for the sake of illustration, the workflow or pipeline of FIG. 2 is explained using two medical images. However, the techniques of the present disclosure are equally applicable for processing more than two medical images captured at different time instances (e.g., regular time instances) of a particular modality for monitoring growth or rate of growth of the medical condition. In the present disclosure, the training of various models is not described in detail. Typically, for training, the apparatus 101 may divide or split an input dataset in a pre-defined ratio of training and testing datasets. In one example, the pre-defined ratio may be 70:30 or 80:20. The training dataset is typically used to train models while the testing dataset is typically used to evaluate performance of the trained models. The testing datasets may be referred as validation datasets. The training may be performed offline, and the trained models are deployed for real-time inferencing. In one example, the models may be automatically retrained to adapt to evolving input data.

FIG. 6 shows a flowchart illustrating a method 600 for monitoring growth of a medical condition in a subject, in accordance with some embodiments of the present disclosure. The various operations of the method 600 may be performed with the help of the apparatus 101 and specifically, with the help of the processor 108 which is communicatively coupled with the memory 110.

As illustrated in FIG. 6, the method 600 may include, at a block 602, processing, using a trained modality classification model 204, at least two input medical images 202-1, 202-2 representing the medical condition to identify an image modality, among a plurality of image modalities, associated with the at least two input medical images 202-1, 202-2. For example, the processor 108 may be configured to process, using the trained modality classification model 204, the at least two input medical images 202-1, 202-2 to identify an image modality associated with the at least two input medical images 202-1, 202-2.

The method 600 may include, at block 604, processing the at least two input medical images 202-1, 202-2 using a multi-modal segmentation model 206 (which is specifically trained for the identified image modality) to generate at least two segmented images 208-1, 208-2 corresponding to the at least two input medical images 202-1, 202-2. For example, the processor 108 may be configured to process the at least two input medical images 202-1, 202-2 using the multi-modal segmentation model 206 to generate at least two segmented images 208-1, 208-2 corresponding to the at least two input medical images 202-1, 202-2.

The method 600 may include, at block 606, processing the at least two input medical images 202-1, 202-2 and the at least two segmented images 208-1, 208-2 using a radiomic feature extraction model 210 to extract at least two sets of radiomic features 212-1, 212-2 corresponding to the at least two input medical images 202-1, 202-2. For example, the processor 108 may be configured to process the at least two input medical images 202-1, 202-2 and the at least two segmented images 208-1, 208-2 to extract at least two sets of radiomic features 212-1, 212-2 corresponding to the at least two input medical images 202-1, 202-2.

The method 600 may include, at block 608, monitoring the growth of the medical condition in the subject by comparing corresponding radiomic features of the at least two sets of radiomic features 212-1, 212-2. For example, the processor 108 may be configured to monitor the growth of the medical condition in the subject by comparing corresponding radiomic features of the at least two sets of radiomic features 212-1, 212-2.

The method 600 may include, at block 610, processing one or more of the at least two sets of radiomic features 212-1, 212-2 using a trained radiomic feature classification model 218 (also referred to as “reoccurrence prediction model”) to determine a prediction score indicating probability of future reoccurrence of the medical condition in the subject. For example, the processor 108 may be configured to process one or more of the at least two sets of radiomic features 212-1, 212-2 to determine the prediction score indicating probability of future reoccurrence of the medical condition in the subject.

The order in which the various operations of the methods are described is not intended to be construed as a limitation, and any number of the described method blocks can be combined in any order to implement the method. Additionally, individual blocks may be deleted from the methods without departing from the spirit and scope of the subject matter described herein. Furthermore, the methods can be implemented in any suitable hardware, software, firmware, or combination thereof.

The various operations of methods described above may be performed by any suitable means capable of performing the corresponding functions. Generally, where there are operations illustrated in Figures, those operations may have corresponding counterpart means-plus-function components. It may be noted here that the subject matter of some or all embodiments described with reference to FIGS. 1-5 may be relevant for the method and apparatus and the same is not repeated for the sake of brevity.

In a non-limiting embodiment of the present disclosure, one or more non-transitory computer-readable media may be utilized for implementing the embodiments consistent with the present disclosure. A computer-readable media refers to any type of physical memory (such as the memory 110) on which information or data readable by a processor may be stored. Thus, a computer-readable media may store one or more instructions for execution by the at least one processor 108, including instructions for causing the at least one processor 108 to perform steps or stages consistent with the embodiments described herein. Certain aspects may comprise a computer program product for performing the operations presented herein. For example, such a computer program product may comprise a computer readable media having instructions stored (and/or encoded) thereon, the instructions being executable by one or more processors to perform the operations described herein. For certain aspects, the computer program product may include packaging material.

As used herein, a phrase referring to “at least one” or “one or more” of a list of items refers to any combination of those items, including single members. As an example, “at least one of: a, b, or c” is intended to cover: a, b, c, a-b, a-c, b-c, and a-b-c. The terms “a”, “an” and “the” mean “one or more”, unless expressly specified otherwise. The terms “including”, “comprising”, “having” and variations thereof, when used in a claim, is used in a non-exclusive sense that is not intended to exclude the presence of other elements or steps in a claimed structure or method, unless expressly specified otherwise.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based here on. Accordingly, the embodiments of the present disclosure are intended to be illustrative, but not limiting, of the scope of the invention, which is set forth in the appended claims.

What is claimed is:

1. An apparatus for monitoring growth of a medical condition in a subject, the apparatus comprising:
a memory; and
a processor communicatively coupled with the memory, wherein the processor is configured to:
process, using a trained modality classification model, at least two input medical images representing the medical condition to identify an image modality, among a plurality of image modalities, associated with the at least two input medical images;
process the at least two input medical images using a segmentation model which is specifically trained for the identified image modality to generate at least two segmented images corresponding to the at least two input medical images;
process the at least two input medical images and the at least two segmented images to extract at least two sets of radiomic features corresponding to the at least two input medical images; and
monitor the growth of the medical condition in the subject by comparing corresponding radiomic features of the at least two sets of radiomic features.

2. The apparatus of claim 1, wherein the processor is further configured to:
select the segmentation model for the identified image modality among a plurality of trained segmentation models corresponding to the plurality of image modalities, wherein the plurality of trained segmentation models form a multi-modal image segmentation model.

3. The apparatus of claim 1, wherein the processor is further configured to:
process one or more of the at least two sets of radiomic features using a trained radiomic feature classification model to determine a prediction score indicating probability of future reoccurrence of the medical condition in the subject; and
provide an indication related to the growth of the medical condition and the future reoccurrence of the medical condition.

4. The apparatus of claim 1, wherein the medical condition comprises cancer, tumor, and other related medical conditions; and wherein the plurality of image modalities comprises medical imaging techniques including: X-Ray, Magnetic Resonance Imaging (MRI) scan, Computed Tomography (CT) scan, Ultrasound, Positron Emission Tomography (PET) scan, Endoscopy, Mammography, Bone scan.

5. The apparatus of claim 1, wherein the at least two input medical images are captured at different time instances during lifetime of the subject, and
wherein to compare the corresponding radiomic features of the two sets of radiomic features, the processor is configured to calculate differences in the corresponding radiomic features over time to monitor the growth of the medical condition.

6. The apparatus of claim 1, wherein the segmentation model is a deep learning model trained to identify regions of interest corresponding to the medical condition in input medical images of the identified image modality.

7. A method for monitoring growth of a medical condition in a subject, the method comprising:
processing, using a trained modality classification model, at least two input medical images representing the medical condition to identify an image modality, among a plurality of image modalities, associated with the at least two input medical images;
processing the at least two input medical images using a segmentation model which is specifically trained for the identified image modality to generate at least two segmented images corresponding to the at least two input medical images;
processing the at least two input medical images and the at least two segmented images to extract at least two sets of radiomic features corresponding to the at least two input medical images; and
monitoring the growth of the medical condition in the subject by comparing corresponding radiomic features of the at least two sets of radiomic features.

8. The method of claim 7, further comprising:
selecting the segmentation model for the identified image modality among a plurality of trained segmentation models corresponding to the plurality of image modalities, wherein the plurality of trained segmentation models form a multi-modal image segmentation model.

9. The method of claim 7, further comprising:
processing one or more of the at least two sets of radiomic features using a trained radiomic feature classification model to determine a prediction score indicating probability of future reoccurrence of the medical condition in the subject; and
providing an indication related to the growth of the medical condition and the future reoccurrence of the medical condition.

10. The method of claim 7, wherein the medical condition comprises cancer, tumor, and other related medical conditions; and wherein the plurality of image modalities comprises medical imaging techniques including: X-Ray, Magnetic Resonance Imaging (MRI) scan, Computed Tomography (CT) scan, Ultrasound, Positron Emission Tomography (PET) scan, Endoscopy, Mammography, Bone scan.

11. The method of claim 7, wherein the at least two input medical images are captured at different time instances during lifetime of the subject, and wherein comparing corresponding radiomic features of the two sets of radiomic features comprises calculating differences in the corresponding radiomic features over time to monitor the growth of the medical condition.

12. The method of claim 7, wherein the segmentation model is a deep learning model trained to identify regions of interest corresponding to the medical condition in input medical images of the identified image modality.

13. A non-transitory computer-readable medium storing computer-executable instructions for monitoring growth of a medical condition in a subject, the computer-executable instructions configured for:
processing, using a trained modality classification model, at least two input medical images representing the medical condition to identify an image modality, among a plurality of image modalities, associated with the at least two input medical images;
processing the at least two input medical images using a segmentation model which is specifically trained for the identified image modality to generate at least two segmented images corresponding to the at least two input medical images;
processing the at least two input medical images and the at least two segmented images to extract at least two sets of radiomic features corresponding to the at least two input medical images; and
monitoring the growth of the medical condition in the subject by comparing corresponding radiomic features of the at least two sets of radiomic features.

14. The non-transitory computer-readable medium of claim 13, wherein the computer-executable instructions are further configured for:
selecting the segmentation model for the identified image modality among a plurality of trained segmentation models corresponding to the plurality of image modalities, wherein the plurality of trained segmentation models form a multi-modal image segmentation model.

15. The non-transitory computer-readable medium of claim 13, wherein the computer-executable instructions are further configured for:
processing one or more of the at least two sets of radiomic features using a trained radiomic feature classification model to determine a prediction score indicating probability of future reoccurrence of the medical condition in the subject; and
providing an indication related to the growth of the medical condition and the future reoccurrence of the medical condition.

16. The non-transitory computer-readable medium of claim 13, wherein the medical condition comprises cancer, tumor, and other related medical conditions; and wherein the plurality of image modalities comprises medical imaging techniques including: X-Ray, Magnetic Resonance Imaging (MRI) scan, Computed Tomography (CT) scan, Ultrasound, Positron Emission Tomography (PET) scan, Endoscopy, Mammography, Bone scan.

17. The non-transitory computer-readable medium of claim 13, wherein the at least two input medical images are captured at different time instances during lifetime of the subject, and wherein comparing corresponding radiomic features of the two sets of radiomic features comprises calculating differences in the corresponding radiomic features over time to monitor the growth of the medical condition.

18. The non-transitory computer-readable medium of claim 13, wherein the segmentation model is a deep learning model trained to identify regions of interest corresponding to the medical condition in input medical images of the identified image modality.
